(19) United States
(12) Patent Application Publication
(10) Pub. No.: US 2008/0202934 A1
(43) Pub. Date: Aug. 28, 2008

(54) Method and Apparatus for the Simultaneous Separation of Biological Molecules by Two Dimensional Electrophoresis

(75) Inventors: Renato Millioni, Padova (IT); Antonio Guadagnino, Padova (IT); Manuela Miuzzo, Feltre (IT); Elisa Barina, Padova (IT); Tommaso Salata, Padova (IT); Piergiorgio Righetti, Milano (IT)

Correspondence Address: Jay S Cinamon;ABELMAN FRAYNE & SCHWAB, Tenth Floor, 666 Third Avenue, New York, NY, 10017-5621, US

(73) Assignee: P DIMENSIONAL S.R.L., Padova (IT)

(21) Appl. No.: 11/791,728

(22) PCT Filed: Nov. 24, 2005
(86) PCT No.: PCT/IB05/03519

§ 371 Date: May 25, 2007

(30) Foreign Application Priority Data
Nov. 26, 2004 (IT) PD2004 A 000301

(51) Int. Cl. B01D 57/02

(52) U.S. Cl. 204/548; 204/450; 204/549; 204/600

(57) ABSTRACT

The patent describes a method for the simultaneous and repeatable separation of biological molecules by bidimensional electrophoresis and the apparatus usable to carry out thereof. And in particular, the present invention refers to a method and to an apparatus as defined above, capable to transfer and separate, on a matrix, of protein and/or polypeptide and/or peptide components that were previously ordered on another matrix according to specific chemical and/or physical characteristics.

### FIELD OF THE INVENTION

The present invention is relative to a method for the electrophoretical bidimensional separation of biomolecules, and in particular protein and/or polypeptide and/or peptide components contained in a biological sample, obtained by an application of an electrical field having non-parallel lines of force and an apparatus usable therefor.

### STATE OF THE ART

Actually a great number of techniques are used for separating biological molecules, in particular proteins. In fact, numerous electrophoretical techniques (e.g. electrophoresis on polyacrylamide gels, capillary electrophoresis, isoelectrofocalization) and chromatography techniques (e.g. ion-exchange, affinity, gel-filtration chromatography) are in use. As it is known, today the most efficient method of separation for simultaneously isolating thousands of proteins is bidimensional electrophoresis (2-D PAGE); this process comprises:
isoelectrofocalization (IEF, first dimension), that is, the separation of proteins on a polyacrylamide matrix according to their isoelectric points;
equilibration, in which a constant charge/mass ratio of proteins is obtained;
electrophoresis on a polyacrylamide matrix in Sodium Dodecyl Sulfate (SDS PAGE, second dimension) in which proteins are separated according to their molecular weights;
coloration of the gel which permits visualization of the proteins contained in spots;
elaboration of the obtained data;
sampling of the spots.

The subsequent identification of the sampled proteins is made via an analysis of mass spectroscopy or other known techniques.

Detailed descriptions of this technique are reported in U.S. Pat. No. 4,088,561. Further evolutions regarding a better integration of the phases of the process are described in the more recent patents: JP 58193446; U.S. Pat. No. 4,874,490; WO 0226773.

Bidimensional electrophoresis is at the base of the field of research of proteomics, the science for which the objective is to determine the entire set of proteins that is expressed in a cell. The goal is to compare the protein set of a healthy cell with that of a sick cell, to determine the font of pathology for the latter, and therefore to assist in the development of new specific therapeutic agents.

It is known that this technique presents a drawback in the separation of diverse components present in biological samples, these components being present in high numbers; and the limitation is above all in the visualisation of components which are present in small amounts in the mixture which is separated. This drawback is due to the presence of proteins and/or polypeptides and/or peptides that have similar molecular weights (MW) and isoeletric points (pl), but different relative abundances, that is, the detectable quantities are very different. This implicates both a small likelihood of being able to identify a large part of the sample tested and difficulty in manual aliquotting of single spots not adequately isolated.

A further drawback consists of the difficulty in characterizing and possibly identifying a single protein when this protein does not result in an adequate separation from the others: that which seems to be a spot consisting of one single protein is often formed by different proteins which have similar characteristics. The characterization and identification of these spots (which are determined using known techniques by one ordinary skilled in the art, for example mass spectroscopy) is not feasible or in some cases results in the identification only of proteins present in more abundant quantities.

The purpose of the present invention is principally, but not exclusively, that of overcoming the previously mentioned drawbacks in order to make possible a significant increase in resolution in the separation of biomolecules, in particular protein and/or polypeptide and/or peptide components.

Another purpose of the invention is to provide an electrophoretic technique, as defined above, capable to guarantee, given a better resolution, a greater practicality in the extraction of single components from starting samples at the end of the process and consequently to permit a more rapid characterization of these components.

Another purpose of the invention is to provide an electrophoretic technique qualified to permit a more accurate identification of the single components of the starting sample.

A further purpose of the invention is to provide an electrophoretic technique which is economically and easily usable in a reproducible manner. And yet another purpose of the invention is to provide an electrophoretic technique which minimizes the preliminary steps of purification/enrichment of the sample, with a consequent reduced loss of sample.

These and other purposes are met by the electrophoretical technique of the present invention, applicable for the separation of biomolecules contained in biological samples, in particular protein and/or polipeptide and/or peptide components previously ordered according to specific chemical and/or physical characteristics.

### SUMMARY

From experiences accomplished by the Inventors, it has been recognized that, from an instrumental point of view, the limitation of resolution in the separation of a biological sample, particularly into its different protein components, which have similar characteristics (for example molecular weight and/or isoelectric point), is above all consequent to the application of an electrical field characterized by parallel lines of force, typical of 2-D PAGE.

The proposed invention is an electrophoretic technique of the bidimensional type which is characterized by the use of an electrical field having non-parallel lines of force capable to transfer and separate on a matrix B the protein and/or polypeptide and/or peptide components of a biological sample, which have previously been ordered on another matrix A according to specific chemical and/or physical characteristics.

Therefore the object of the invention is a method of bidimensional electrophoresis for the simultaneous separation of biomolecules contained in at least one biological sample, comprising at least the step of:
transferring from at least one first matrix, wherein said biomolecules are comprised in said biological sample and are ordered according to chemical and/or physical characteristics, to at least one second matrix wherein said biomolecules are separated from each other, being both the transfer and the separation of the said biomolecules induced by the application of an electrical field having non-parallel lines of force.

A further object of the invention is an apparatus for bidimensional electrophoresis for the simultaneous separation of biomolecules contained in at least one biological sample, characterized by the fact that said apparatus generates at least one electrical field having non-parallel lines of force inside at least one first matrix, wherein said biomolecules are comprised in said biological sample and are ordered according to chemical and/or physical characteristics, and inside at least one second matrix, wherein said biomolecules are separated, being the electrical field generated the means by which said biomolecules are transferred from said first matrix to said second matrix and the means by which said biomolecules are separated.

Such a method and the apparatus to carry out the same are preferably used for the separation of proteins and/or polypeptides and/or peptides with similar chemical and/or physical characteristics and for the characterization of a biological sample containing components of a proteic nature.

### BRIEF DESCRIPTION OF THE FIGURES

FIG. 1: schematic representation of an example of an electrical field with radial diffusion generated by two electrodes.

FIG. 2: schematic representation of an example of an electrical field in the form of a circular sector with radial diffusion generated by two electrodes.

FIG. 3: schematic representation of an example of an electrical field with non-parallel lines of force generated by more than two electrodes.

FIG. 4: schematic representation of a possible embodiment of an apparatus suitable for separating biomolecules and in particular proteins and/or polypeptides and/or peptides, ordered according to specific chemical and/or physical characteristics, by means of an electrical field with non-parallel lines of force in radial diffusion.

FIG. 5: running front evidenced with bromophenol blue of fibroblast proteins separated with traditional bidimensional electrophoresis.

FIG. 6: running front evidenced with bromophenol blue of fibroblast proteins separated with bidimensional electrophoresis according to the invention.

FIG. 7: image of the separation of fibroblast proteins on the basis of molecular weight separated with traditional bidimensional electrophoresis.

FIG. 8: image of the separation of fibroblast proteins on the basis of molecular weight separated with bidimensional electrophoresis according to the invention.

### DETAILED DESCRIPTION OF THE INVENTION

The purposes and the advantages of the electrophoretic method and of the apparatus, object of the invention, will be better understood from the following detailed description, whereby the essential aspects of the same and its possible embodiments are described.

The electrophoretic method, for the simultaneous separation of biomolecules contained in a biological sample, comprising at least the step of separating such biomolecules in an adequate matrix on an adequate support, and in particular proteins and/or polypeptides and/or peptides, by means of an application of an electrical field having non-parallel lines of force, is substantially a bidimensional electrophoretic method carried out in an apparatus wherein the lines of force of the electrical field are determined by at least two electrodes, of which at least one is positive and at least one is negative. Said lines of force are determined in a first matrix A, containing the biological sample or samples to be tested, and in a second matrix B in which the biomolecule's components, particularly those having a proteic nature, are transferred and then separated, by: an opportune geometry of such aforementioned electrodes, and/or the shape of the aforementioned matrices, and/or their placement with respect to the electrodes, and/or the conducting material (electrolytic buffer) contained between such electrodes and such matrices.

To provide an example of a preferred placement inside an electrophoretic cell, to obtain an electric field with non-parallel lines of force, there might be an electrode J situated on a plain along a circumference at the centre of which a puntiform electrode K (with charge opposite to J) is placed.

As known, inside an electrophoretic cell, different components are present (container, matrix, electrolytic buffer etc.) which are capable of influencing direction and/or shape of the lines of force of the electric field generated by the electrodes; it is therefore essential to conform and place the above mentioned elements in such a way that reproducible lines of force are obtainable and are adapted to the type of separation of the biological sample pursued.

Such electrodes, however, are placed in a manner to generate substantially a continuous or discontinuous electrical field in an area of a plane, comprised amongst the electrodes themselves, wherein an electric field with non-parallel lines of force, preferably divergent or convergent according to the polarity of the electrical field itself, of variable duration and intensity, according to the type of sample undergoing electrophoretic separation, is generated.

The characteristics of the electrical field generated influence the separation. The choice of voltage to apply will therefore depend on the time of application determined by the operator and generally will be around a value between 30 and 600 V and depending on the type of sample that needs to be separated, on the basis of the dimensions of the matrix and the distance between the electrodes, on the conductivity of the system and on the desired quality level of the separation. In order to obtain a bidimensional electrophoretic separation, the starting biological sample or samples may be treated, following known procedures for the electrophoresis of proteic materials. In this case the biological sample(s) to be tested may be preliminarily subjected, and in any case before the electrophoretic separation via an electrical field with non-parellel lines of force, to:
a treatment to obtain a first separation of biomolecules and in particular proteins and/or polypeptides and/or peptides on a first matrix on the basis of their chemical or physical characteristics;
a further treatment to confer to these biomolecules (proteins and/or polypeptides and/or peptides) a constant charge/mass ratio.

The separation in the first dimension, that is, on matrix A, may be obtained by zonal electrophoresis, by disc electrophoresis, by isotacophoresis, or by isoelectrofocalization either in amphoteric soluble buffers or in a pH gradient immobilized on opportune continuous or granulated anticonvective matrices. Such matrices may be, but are not limited to, polyacrylamide, agarose, acetate gels, cross-linked dextrans. Furthermore, such anticonvective matrices for the first dimension may be anchored by traditional plastic supports (e.g., Gel Bond PAG, Gel Bond agarose) or rather by porous supports permeable to electrical current (e.g., cellulose acetate sheets, nylon mesh, fibreglass sheets).

The second matrix useable for the bidimensional electrophoresis, which is the object of the invention, may be instead a polymer with a constant concentration or else in a porosity gradient to optimise the separation of proteins/peptides (either in native conditions or in presence of denaturants) on the basis of their molecular masses, in the presence of continuous or discontinuous buffers. Such polymers may be, for example, mixtures of acrylamide and bis-acrylamdie, agarose, and/or cellulose acetate.

The area in which the electrical field with non-parallel lines of force is produced may furthermore allow for an interstitial space, between the first matrix A and the second matrix B, in which a third matrix may be added (for example agarose) which permits continuity between the matrices A and B and so rendering possible the migration of the sample from matrix A to matrix B.

In another aspect the first matrix A, opportunely inserted into the electrophoretic cell for the second dimension, is fused to matrix B for the second electrophoresis, obtained by the non-parallel lines of force, by direct polymerization, in situ, of the second matrix B placed very close to the first matrix A, thereby eliminating any interstitial space.

Optionally the sample(s) may preliminarily be subjected to a thermal denaturation by heating the sample or to a chemical denaturation by treating the sample with denaturing agents as with, for example, urea, thiourea, surfactants, and/or organic solvents, or a mixture thereof and/or a reduction with reducing agents as with, for example, beta-mercaptoethanol, dithiothreitol, or tributyl phosphine. Otherwise successive to the denaturation and/or reduction the sample(s) may optionally be subjected to an alkylation. The alkylating agents may be, for example, iodoacetamide, acrylamide, N-substituted acrylamide, or vinyl-pyridine.

The bidimensional electrophoresis of the invention therefore provides for:
1- preparation of the biological sample;
2- first separation in a first matrix A to order the biomolecules, in particular the protein and/or polypeptide and/or peptide components, of the sample according to chemical and/or physical characteristics;
3- treatment of the matrix A in order to make uniform the components contained in it, on the basis of electrical charge;
4- insertion of matrix A into the apparatus in a manner that matrix A is positioned between at least an electrode and at least a second matrix B, which is placed in proximity to at least a second electrode;
5- addition of an electrolytic solution inside the apparatus in the area comprised between the electrodes wherein the matrices are placed and wherein the electrical field is induced;
6- application of an electrical field, having non-parallel lines of force, suitable for transferring of protein and/or polypeptide and/or peptide components, previously ordered according to chemical and/or physical characteristics, from matrix A to matrix B, wherein a further separation occurs.

Said bidimensional electrophoresis provides for the application of an electrical field having non-parallel lines of force in an area comprising at least two matrices placed one following the other where at least a first matrix A is in proximity of at least a first electrode and at least a second matrix B is placed between the first matrix A and at least a second electrode having a charge opposite to that of the first electrode.

Having finished the bidimensional electrophoresis, the proteins may be visualized and sampled from matrix B, in which they have been separated, and identified with techniques of sequencing and/or mass spectrometry and/or other methods known to one ordinary skilled in the art.

The method may also be used for the characterization of a biological sample in which the separated proteins are visualised by densitometry, autoradiography, chemiluminescence or fluorescence, or assayed by biological activity (for example antigen-antibody reactions or zymograms) before being examined for their identification.

In a first aspect the present invention therefore allows the separation of one or more biological samples into their components and in particular into protein and/or polypeptide and/or peptide components, previously ordered according to specific chemical and/or physical characteristics, placed inside an electrophoretic apparatus comprising:
at least two electrodes suitable for generating an electrical field having non-parallel lines of force;
at least one plane comprising inside at least an area between the electrodes wherein an electrical field characterized by non-parallel lines of force is generated, said plane comprising at least a support suitable for containing at least one or more matrices placed close to each other in the area comprised between the electrodes, of which: (i) a first matrix A wherein the biomolecoles, and in particular the protein and/or polypeptide and/or peptide components, from one or more biological samples have been previously ordered according to specific chemical and/or physical characteristics; (ii) a second matrix B wherein the biomolecules from the aforementioned biological samples are made to migrate from the first matrix A, in order that a further separation will be obtained with respect to that carried out in the first matrix A. Optionally the first matrix A and the second matrix B may be placed on their own separate supports and even when the supports for the matrices are different they are comprised in the same plane and maintain the same geometry with respect to the electrodes. Such planes may indifferently be horizontal or vertical;
at least a power supply for the electrical field which may either be part of the apparatus itself or may be externally attached;
optionally at least a means capable of keeping the system at a constant predetermined temperature, for example, a thermostat. Alternatively to a thermostat the apparatus can be positioned in a temperature-controlled setting.

With the purpose to obtain the desired bidimensional electrophoretic separation, the plane comprising the area in which the matrices for electrophoresis are positioned may have any shape, for example, a circular or other shape, provided that the shape is adapted to allow the production of an electrical field with the pursued non-parallel lines of force which are necessary to obtain the desired simultaneous separation of the proteic material.

In a possible embodiment the structure of the apparatus is substantially a cylindrical cell for electrophoresis and comprises inside the electrodes. When said cell is closed, this further delimits portions where the electrodes are positioned and portions comprised between them. Furthermore such a cell may be of any material known to be electrically non-conductive to assure that it does not short-circuit or disperse the current, generated by a suitable power supply, which passes through the area comprised between the electrodes, as well as for safe use. Such materials may be, for example, polymers such as, for example, polymethylacrylate, polycarbonate, polypropylene, or polyethylene; glass; elastomers.

Furthermore the cell may comprises electrical connectors to connect the current to the electrodes.

In a preferred embodiment the cell may comprise more distinct areas in each of which an electrical field with non-parellel lines of forces is created. Preferably the areas in which the electrical field is created are matrices placed on an adequate support of the kind commonly used for the separation of proteic materials from biological samples, said matrices can be constitute, for example, by mixtures of polyacrylamide and can have various densities depending on the type of separation. In this case the simultaneous separation of biomolecules from different biological samples may be obtained.

The electrodes are made of materials known by an expert of the field and may be, for example, in titanium coated with platinum, without however excluding other materials suitable for serving as electrodes. The positive electrode is preferably positioned in a position that is coplanar with reference to the negative electrode. The matrices placed between the electrodes, in which an electrical field will be generated, are delimited by the same electrodes, preferably but not necessarily concentric. The cell as a whole may be substantially of a cylindrical or parallelogram or other shape adapted for the purpose.

Furthermore, the distinct areas formed by the matrices, in which the electrical field with non-parallel lines of force is created, may be preferably positioned in such a way as to be overlaid vertically or rather side by side. The portions of the apparatus, in which the electrodes are positioned, are immersed in an electrolytic solution which permits a continuous charge transmission between the electrodes and the matrices placed in the area, in which the electrical field with non-parallel lines of force is created. This way the proteic material to be separated migrates under the action of a potential difference.

The temperature of the electrolytic solution is controlled and preferably by an appropriate thermostat suitable for maintaining the system at a constant predetermined temperature.

In addition, the apparatus may have its own power supply or may be connected to an external power supply.

The modality of execution of the technique of the present invention may be better evidenced in the following detailed description, in which reference is made to the attached list of figures representing some forms of preferred and non-limiting embodiments and wherein:

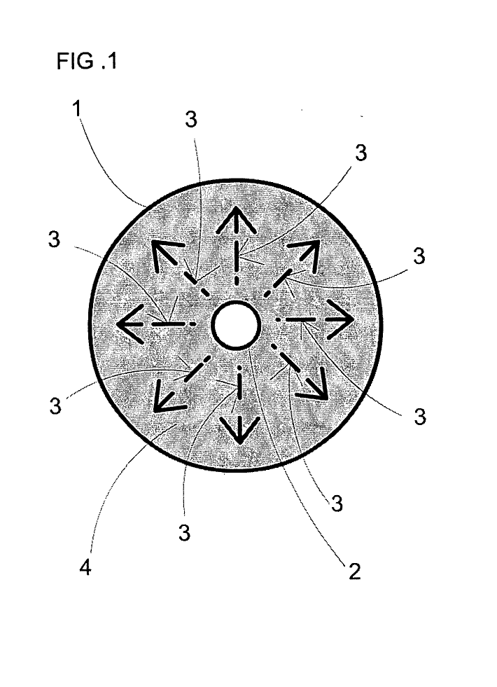

FIG. 1 shows a schematic representation of an area in which an electrical field in the shape of a circular crown, with non-parallel and divergent lines of force, at radial diffusion is generated by two electrodes electrically different between themselves, in which 1 is the external portion of the electrical field in which at least one electrode is placed, 2 is the internal portion of the electrical field in which is at least one second electrode is positioned, having an electrical charge different from the first, 3 represents the lines of force generated by the electrical field, and 4 is the electrical field itself;

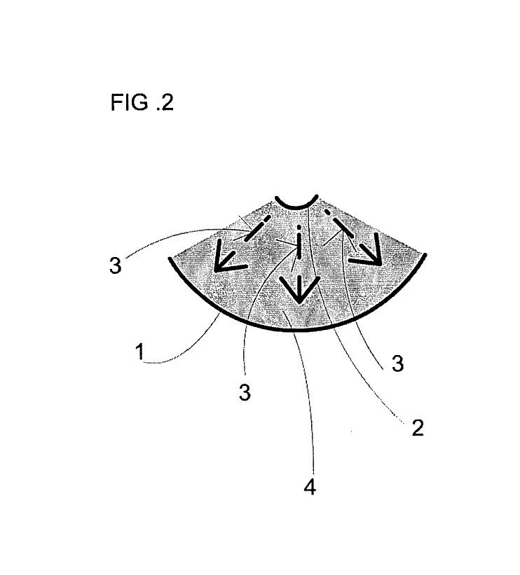

FIG. 2 shows a schematic representation of an area in which an electrical field in the shape of a circular sector, with non-parallel lines of force at radial diffusion, is generated by at least two electrodes in which 1, 2, 3 and 4 have the same meanings as in FIG. 1;

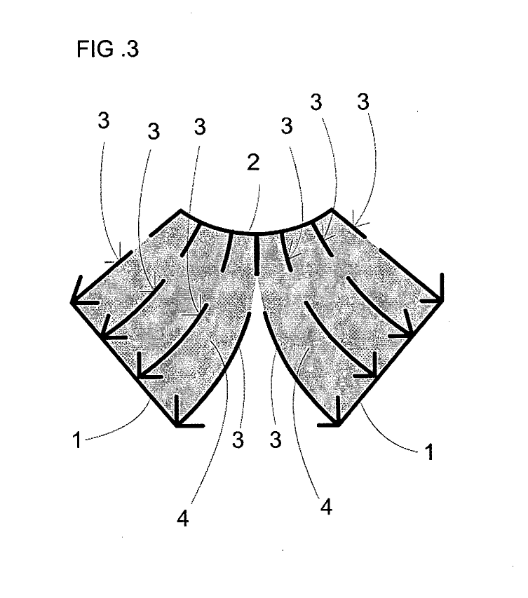

FIG. 3 shows a schematic representation of an area in which an electrical field with non-parallel lines of force is generated by more than two electrodes, according to an alternative form of embodiment, in which 1 is the portion of the electrical field in which more electrodes are positioned having among them equal electrical charges, 2 is the portion of the electrical field in which more electrodes are positioned, having electrical charges equal among them but different from those of 1, 3 represents the lines of force generated by the electrical field and 4 is the electrical field itself.

Therefore with reference to the cited figures the apparatus used to carry out the method of electrophoresis, object of the present invention, comprises at least one electrical field 4, characterized by non-parallel lines of force 3, obtained by a power supply connected to at least one electrode, for example, a cathode 2 ,and at least one second electrode, for example, an anode 1.

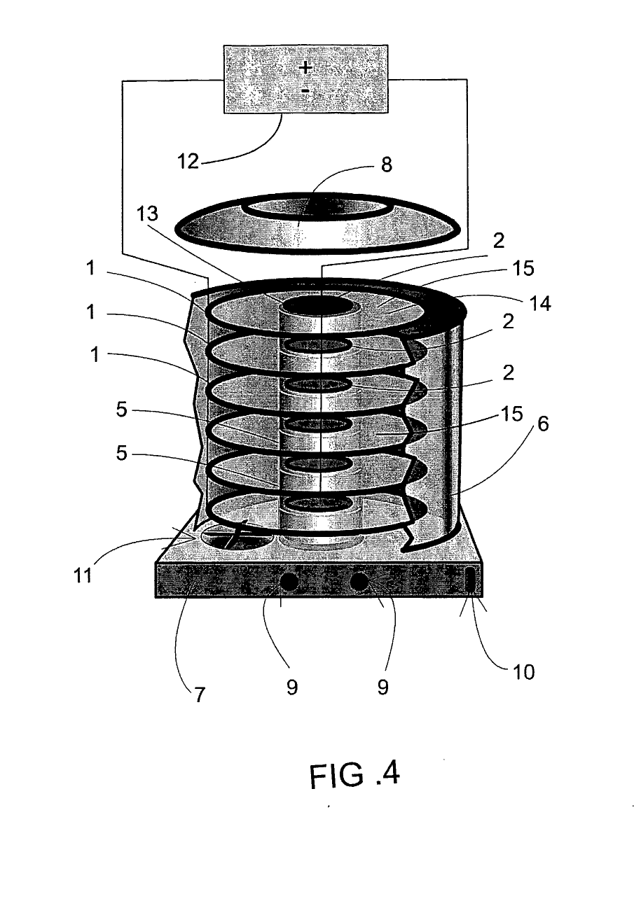

FIG. 4 shows a schematic representation of a thermostateted apparatus used to separate biomolecules, and in particular proteins and/or polypeptides and/or peptides ordered according to specific chemical and/or physical characteristics, via an electrical field with non-parallel lines of force in radial diffusion generated by at least two electrodes 1 and 2, as previously described, connected to a power supply 12, and in particular FIG. 4 shows a cylindrical structure delimited at its extremities by a lid 8, and by a support base 7, which hosts:
a refrigerating liquid;
a fan 11 to diffuse the refrigerating effect;
holes 9, for the exchange of refrigerating liquid with the thermostat;
electrical supply 10 to support the fan 11 functioning.

The apparatus comprises inside, as example, 6 areas for the separation of biological samples. In each area is placed a matrix A 13 around the electrode, 2, on which the biological sample, previously ordered according to chemical and/or physical characteristics, can be is positioned, and then a matrix B 14, placed on the its own support 15, in an area delimited by electrode 1 and by the matrix A 13, suitable for, due to the action of an electrical field with non-parallel lines of force, determining the migration of the biological sample, departing from the said matrix A 13, and subsequently separating it into its components.

Without departing from the scope of the invention the fan 11, and the holes 9, for the exchange of refrigerant liquid with the thermostat and the electrical current supply 10 of the fan 11, may also be localised in portions of the electrophoretic cell other than at the base.

To provide an example, an electrophoretic analysis is described for a biological sample according to the method of the invention in comparison to traditional bid imensional electrophoresis.

### Example of Electrophoretic Separation of Fibroblast Proteins

A proteic sample obtained from human fibroblasts in culture and dissolved in a solution of distilled water containing 8 M urea, 4% chaps, 2% IPG buffer (pH 4-7), 60 mM dithyothreitol (DTT) was used .

In both techniques the proteic sample was inserted into a matrix of polyacrylamide containing a gradient of immobilized pH (in this example in a range of separation of pH 4-7) and was subsequently separated into its components, on the basis of their isoelectric points by means of isoelectrofocalization. Then the sample underwent to a treatment with an equilibration buffer to optimize a constant charge/mass ratio of the aforementioned components.

Composition of the equilibration buffer:

50 mM Tris-HCl pH 8.8, 6 M urea, 30% glycerol, 2% SDS, 0.002% bromophenol blue (w/v).

In the traditional bidimensional electrophoresis the sample contained in the first matrix is transferred by an application of an electrical field characterized by parallel lines of force to a second polyacrylamide matrix with a rectangular form designated to carry out an SDS-PAGE in which the components of the test sample are further separated as a function of their molecular weight.

According to the method of the invention the first matrix containing the components of the sample separated on the basis of isoelectric point and equilibrated is circularized and placed inside an electrical field in the form of a circular crown in which the components of the test sample are further separated, in a second polyacrylamide matrix in the form of a circular crown designated to carry out an SDS-PAGE, as a function of their molecular weights.

In both experiments the characteristics of the second matrix are the following:
composition: 10% acrylamide, 0.4% N,N′-methylenebisacrylamide, 1% Sodium Dodecyl Sulfate, 40 mM Tris-HCl (pH 8.8), 0.5% ammonium persulfate.

In both experiments, at the end of the SDS-PAGE, the matrix and the sample contained in it have undergone the following steps:
(i) staining with Coomassie Blue colorant for four hours at room temperature.
(ii) destaining with aqueous solution containing methanol and acetic acid for 24 hours at room temperature.

Finally, the digital acquisition of the image is carried out using a transmission scanner.

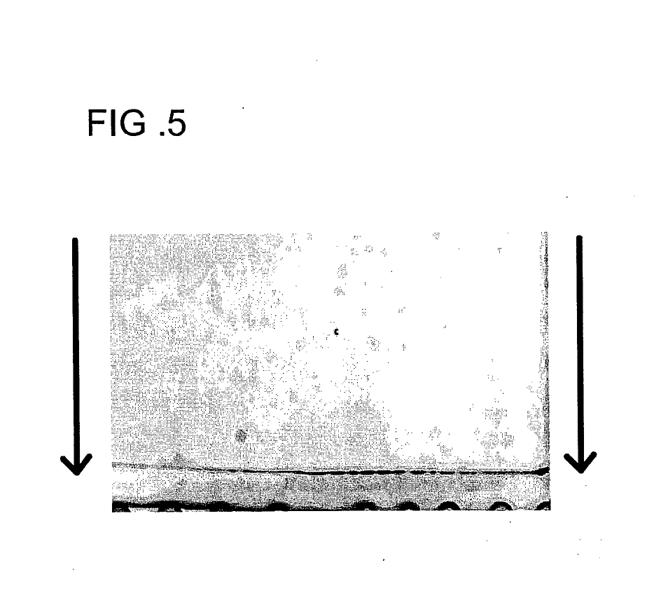

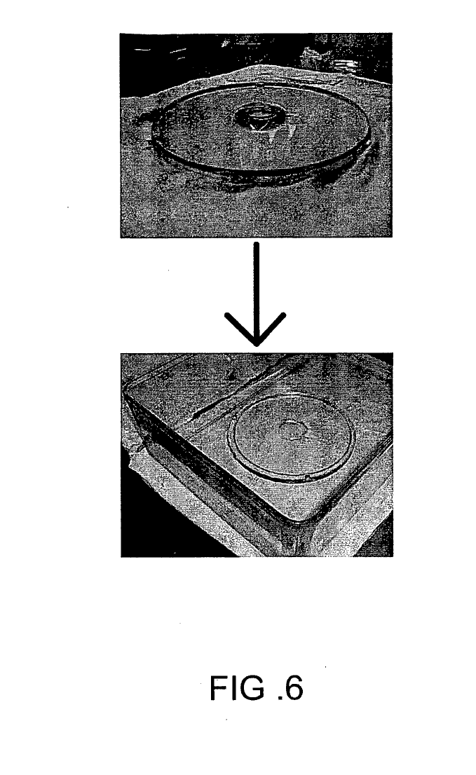

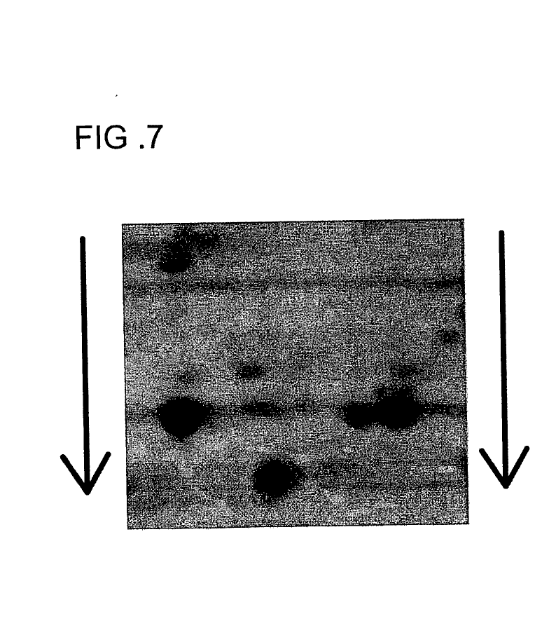

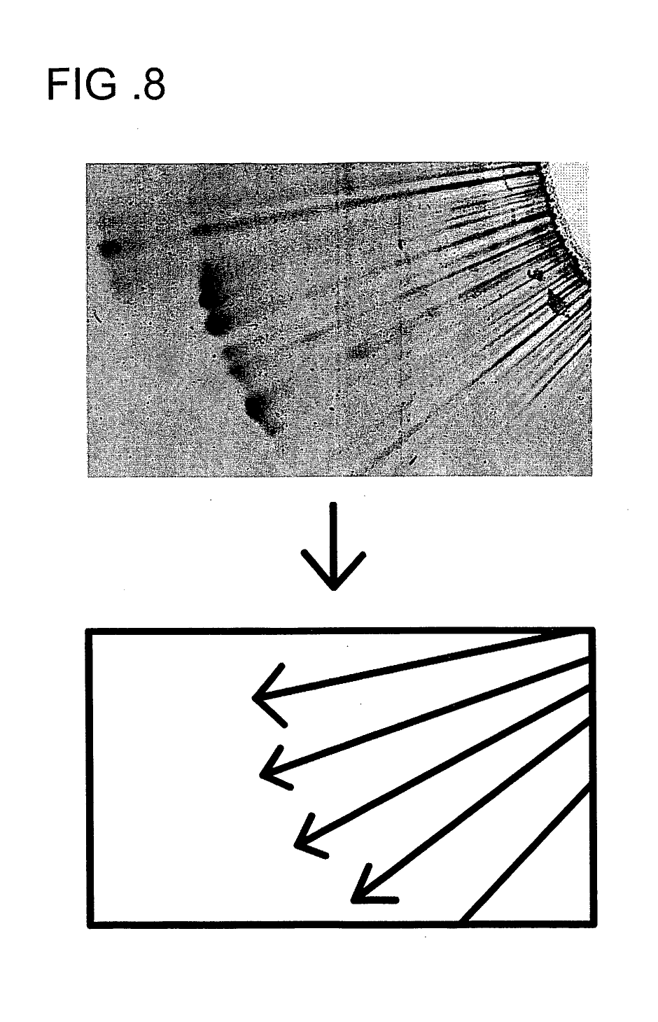

The differences between the electrophoretic runs when using the traditional method and that of the present invention can be noted respectively in FIGS. 5 and 6 due to the presence of bromophenol blue tracer. In FIG. 5 the arrows indicate the direction of the electrophoretic run. In FIG. 6 the tracer at the end of the electrophoretic run is seen. In FIGS. 7 and 8 the differences between runs of a group of proteic spots carried out using the traditional method (FIG. 7) and those using the method of the present invention (FIG. 8) can be noted: the innovation allows for an increased resolution in that the relative distances between the spots increases during their radial separation. In absence of such a radial separation it would not be possible to distinguish the shown spots in FIG. 8 from each other as is evidenced in the diagram below.

Although the invention has been described with regard to some forms of its embodiments, given to illustrate and not to limit the invention, numerous modifications and variations appear to be evident to an expert of the field in light of the description reported above. The present invention in any case, intends to include all the modifications and variants which is encompassed in the scope of the claims which follow.

1. A method of two-dimensional electrophoresis for the simultaneous separation of biomolecules contained in at least one biological sample, comprising at least the step of:
transferring from at least one first matrix one or more of said biomolecules comprised in said biological sample, wherein said biomolecules are ordered according to chemical and/or physical characteristics, in at least one second matrix wherein said biomolecules are separated each from other, being both the transfer and the separation of said biomolecules induced by the application of an electrical field having non-parallel lines of force obtained by means of at least one first electrode placed on a plane along a circumference or portion thereof and at least one second electrode having a charge opposite to that of the first electrode placed in the centre of the circular area or sector comprised in the said circumference or portion thereof.

2. The method of two-dimensional electrophoresis according to claim 1, comprising the further steps of:
treating the sample(s) in order to carry out a first separation of biomolecules contained in the sample(s) on a first matrix;
treating said first matrix containing the sample(s) obtained at the previous step in order to confer a constant charge/mass ratio to the biomolecules making uniform said biomolecules of the sample on the basis of electrical charge.

3. The method of two-dimensional electrophoresis according to claim 2, wherein the separation in the first dimension is obtained either by zonal electrophoresis, or by disc electrophoresis, or by isotacophoresis, or by isoelectrofocalization in amphoteric soluble buffers or by gradients of immobilized pH through opportune anti-convective matrices.

4. The method of two-dimensional electrophoresis according to claim 3, wherein said anti-convective matrices are continuous or granulated and are selected in the group consisting of polyacrylamide, agarose, acetate gels, or cross-linked dextrans.

5. The method of two-dimensional electrophoresis according to claim 3, wherein said anti-convective matrices for the first dimension are anchored to plastic supports or porous supports permeable to the electrical current.

6. The method of two-dimensional electrophoresis according to claim 5, wherein said supports are selected, when they are made of a plastic, in the group consisting of Gel Bond PAG, Gel Bond agarose or, when they are porous supports, in the group consisting of cellulose acetate sheets, nylon meshes, or fibreglass sheets.

7. The method of two-dimensional electrophoresis according to claim 1, wherein said first matrix, adequately inserted into the electrophoretic cell for the second dimension, is fused to said second matrix by direct in situ polymerization of said second matrix in order to eliminate the interstitial space between the two matrices.

8. The method of two-dimensional electrophoresis according to claim 1, wherein said second matrix is a polymer at a constant concentration or in a gradient of porosity in presence of continuous or discontinuous buffers.

9. The method of two-dimensional electrophoresis according to claim 8, wherein said polymer is selected in the group consisting of mixtures of acrylamide, bis-acrylamide, agarose, and cellulose acetate.

10. The method of two-dimensional electrophoresis according to claim 1, comprising a further treatment of the sample(s) prior to the electrophoretic separation and optionally comprising a denaturation and/or reduction.

11. The method of two-dimensional electrophoresis according to claim 10, wherein said denaturation is thermic and induced by heating the sample, or chemical obtainable by addition of denaturing and/or reducing agents.

12. The method of two-dimensional electrophoresis according to claim 11, wherein said denaturing agents are selected from the group consisting of urea, thiourea, surfactants and/or organic solvents, or mixtures thereof.

13. The method of two-dimensional electrophoresis according to claim 11, wherein said reducing agents are selected from the group consisting of beta-mercaptoethanol, dithiothreitol, and tributyl phosphine.

14. The method of two-dimensional electrophoresis according to claim 1, comprising a further treatment of the sample(s) prior to the electrophoretic separation and optionally including a denaturation and/or reduction and subsequently an akylation.

15. The method of two-dimensional electrophoresis according to the claim 14, wherein said alkylation is obtainable with agents selected from the group consisting of iodoacetamide, acrylamide, N-substituted acrylamide, and vinyl-pyridine.

16. The method of two-dimensional electrophoresis according to the claims 1, comprising a further step of visualization of the biological sample contained in the second matrix and separated electrophoretically.

17. The method of two-dimensional electrophoresis according to claim 16, wherein said visualization is obtainable by densitometry, autoradiography, chemiluminescence, fluorescent acquistion or assay by biological activity.

18. The method of two-dimensional electrophoresis according to claims 1 wherein the non-parallel lines of force of the electrical field are radial.

19. The method of two-dimensional electrophoresis for the simultaneous separation of biomolecules contained in at least one biological sample comprising the steps of:
preparing a biological sample;
carrying out a preliminary separation on at least one first matrix for ordering biomolecules contained in the sample according to chemical and/or physical characteristics;
treating said first matrix for making uniform said biomolecules of the sample on the basis of electrical charge;
inserting said first matrix into an apparatus containing at least two electrodes, placing said first matrix between a first electrode of said electrodes and at least a second matrix placed close to a second electrode of said electrodes wherein said at least one first electrode is placed on a plane along a circumference or portion thereof and said at least one second electrode having a charge opposite to that of the first electrode is placed in the centre of the circular area or sector thereof comprised in said circumference or portion thereof;
adding an electrolytic solution inside said apparatus in the area comprised between said electrodes and comprising said matrices wherein an electrical field having non-parallel lines of force is generated;
generating at least one electrical field having non-parallel lines of force in an area between the said electrodes wherein said matrices are placed for transferring said biomolecules, previously ordered on the first matrix, to the second matrix where a further separation occurs.

20. The method of two-dimensional electrophoresis according to claim 19, wherein the non-parallel lines of force of the electrical field are radial.

21. An apparatus for two-dimensional electrophoresis for the simultaneous separation of biomolecules contained in at least one biological sample, characterized by the fact that said apparatus generates at least one electrical field having non-parallel lines of force inside at least one first matrix, wherein said biomolecules of said biological sample are ordered according to chemical and/or physical characteristics and inside at least one second matrix, wherein said biomolecules are separated, being said generated electrical field the means by which said biomolecules are transferred from said first matrix to said second matrix and the means by which said biomolecules are separated, and being said electrical field having non-parallel lines of force obtained by means of at least one first electrode placed on a plane along a circumference or portion thereof and at least one second electrode having a charge opposite to that of the first electrode placed in the centre of the circular area or sector thereof comprised in said circumference or portion thereof.

22. The apparatus for two-dimensional electrophoresis according to claim 21, wherein at least two of said electrodes are placed inside an area suitable for containing said first matrix and said second matrix placed close each other and conducting material.

23. The apparatus for two-dimensional electrophoresis according to claim 21, wherein said second electrode is a puntiform electrode.

24. The apparatus for two-dimensional electrophoresis according to claim 21, wherein said first matrix is separated by said second matrix by an interstitial space suitable for holding a third matrix, being said third matrix adapted to allow continuity between said first and said second matrices.

25. The apparatus for two-dimensional electrophoresis according to claim 21, wherein said electrical field having non-parallel lines of force is continuous or discontinuous, of variable duration and intensity depending on the sample(s) which is(are) intended to be separated.

26. The apparatus for two-dimensional electrophoresis according to claim 21, further comprising means suitable for controlling the temperature during the entire process of electrophoresis.

27. The apparatus for two-dimensional electrophoresis according to claims 21, wherein the non-parallel lines of force of the electrical field are radial.

28. An apparatus for two-dimensional electrophoresis for simultaneous separation of biomolecules contained in at least one biological sample, comprising:
at least two electrodes wherein at least one first electrode is placed on a plane along a circumference or portion thereof and at least one second electrode having a charge opposite to that of the first electrode is placed in the centre of the circular area or sector thereof comprised in said circumference or portion thereof being said electrodes suitable for generating an electrical field having non-parallel lines of force in a defined area on at least one plane;
said at least one plane further comprising at least one support suitable for containing one or more matrices placed close to each other in said defined area between said electrodes and an electrolytic solution used as conducting material, being said matrices:
(i) at least one first matrix, wherein said biomolecules from one or more biological samples have previously been ordered according to specific chemical and/or physical characteristics and placed close to at least one of said first electrode;
(ii) at least one second matrix, wherein the biomolecules from said biological samples are made to migrate from the first matrix in order to obtain a further separation with respect to that obtained in the first matrix, placed between the said first matrix and close to at least one said second electrode;
and at least one means for power supply for the electrical field which may be either part of the apparatus itself or externally connectable.

29. The apparatus for two-dimensional electrophoresis according to claim 28, further comprising at least one means suitable for maintaining a constant temperature.

30. The apparatus for two-dimensional electrophoresis according to claim 28 wherein the non-parallel lines of force of the electrical field are radial.

35. Use of the method according to the claims 1 or of apparatus according to the claims 21 for the characterization of a biological sample.
